(19) United States
(12) Patent Application Publication
(10) Pub. No.: US 2002/0029987 A1
(43) Pub. Date: Mar. 14, 2002

(54) Disc storage case

(76) Inventor: Shahriar Dardashti, Beverly Hills, CA (US)

Correspondence Address: DOUGLAS N. LARSON, ESQ., OPPENHEIMER WOLFF & DONNELLY LLP, Suite 3800, 2029 Century Park East, Los Angeles, CA, 90067, US

(21) Appl. No.: 09/945,043

(22) Filed: Aug. 31, 2001

Related U.S. Application Data
(62) Division of application No. 09/481,329, filed on Jan. 12, 2000.

(51) Int. Cl. B65D 85/30; A45C 13/40; B42F 13/00

(52) U.S. Cl. 206/312; 206/311; 206/425; 190/102; 190/109; 190/119; 402/79

(57) ABSTRACT

A disc storage case is disclosed for storing discs in a convenient, user-friendly arrangement. The disc storage case allows users to store discs in protective sleeves which are mounted to one or more panels of the storage case rather than mounted at the center of the case. The sleeves are mounted to the panels by a holder mechanism through at least one hole in the sleeve along the sleeve edge. The disc storage case is easier to operate since the holder mechanism does not interfere with the hinge between the side panels. Additionally, the disc storage case stores the discs in a flatter design to maximize the amount of discs that may be stored in a case. The flatter design of the disc storage case of the present invention also reduces the likelihood of spilling the discs and is easier to operate in small spaces since the case does not need to be fully opened to locate and retrieve or insert discs. Further, by allowing the user to store discs in sleeves mounted to more than one panel of the case, the user is better able to organize and locate the stored discs contained within the sleeves.

### BACKGROUND OF THE INVENTION

1. Field of the Invention

The present invention relates to an improved storage case for flat articles. More particularly, the present invention relates to an improved storage case for organizing and locating discs such as compact discs (CDs) and digital video discs (DVDs).

2. Description of the Related Art

In recent years, compact discs and other video discs have become extremely popular. For example, discs are used as one of the preferred methods for recording and listening to music and for utilizing computer programs and games. As such, portable and safe storage cases are necessary for transporting and storing multiple discs. These storage cases typically include an external case comprising pocket sleeves for storing the discs. However, the existing storage cases generally use one set of sleeves within the case to store discs. Typically, the prior art cases include multiple sleeves which are adjacent to the center portion of the storage case. Thus, the user must sort through a stack of discs whenever he is interested in locating a particular disc. This sorting process becomes more burdensome as the number of discs stored in the case increases. Additionally, the prior art cases do not provide any way to conveniently organize discs. If a user is interested in an organizational system, the user must personally implement his own system such as manually organizing the discs alphabetically.

U.S. Pat. No. 5,555,977 to Oshry et al. relates to a sleeve member for storing planar articles such as compact discs. In Oshry et al. FIGS. 13 and 14 show the rail 52 attached to the base 50 at the center of the case at end panel 72. Thus, in Oshry et al. the sleeves which store the compact discs attach at the end panel 72 located between both side panels 74. FIG. 4 of U.S. Pat. No. 4,850,731 to Youngs also shows a compact disc storage container with binder holes 70 at the center of the case.

The prior art also includes other compact disc storage case arrangements. For example, LASERLINE offers a compact disc storage case called the FlipDisc™ where a sleeve is attached to the side of the case opposite the center of the case. However, the FlipDisc™ only connects one sleeve to the side of the case and the rest of the sleeves are connected to the previous sleeve in a series connection.

### SUMMARY OF THE INVENTION

The present invention therefore provides a disc storage case for storing flat articles in a convenient, user-friendly design. The disc storage case allows users to store discs in protective sleeves which are mounted to one or more panels of the storage case rather than at the center of the case. By allowing the user to store discs in sleeves mounted to more than one panel of the case according to one embodiment of this invention, the user is better able to organize and locate the stored articles contained within the sleeves.

For example, if the user listens to classical music and jazz music, he may store his classical music CDs in one set of sleeves and his jazz music CDs in another set of sleeves. Or even if the user only listens to classical music, he may store his CDs by Mozart in one set of sleeves and his CDs by Beethoven in another set of sleeves. Likewise, if the user is storing DVDs, he may store action movie discs in one set of sleeves and comedy movie discs in another set of sleeves.

The embodiment utilizing sleeves mounted to more than one panel of the case is also useful for applications where users share the case. For example, a husband and wife may conveniently store his discs on one side and hers on the other. Also, siblings with different preferences may now separate their discs such that there would be less likelihood of disputes over ownership or control of discs since discs in one set of sleeves belong to one sibling and discs in the other set of sleeves belong to the other sibling.

In addition to the organizational benefits of the within invention, the present disc storage case introduces the discs in a flatter design such that more discs may be stored in a case. The flatter design of the disc storage case of the present invention also reduces the likelihood of spilling the discs and is easier to operate in small spaces such as in a car since the case does not need to be completely opened to locate discs. Further, in the flatter design in the present invention, the holder mechanism does not interfere with the hinge between the side panels so the storage case is easier to operate in general.

The above-described objects of the present invention and other features and benefits of the present invention will become clear to those skilled in the art when read in conjunction with the following detailed description of illustrative embodiments and viewed in conjunction with the attached drawings in which like numbers refer to like parts, and the appended claims.

### BRIEF DESCRIPTION OF THE DRAWINGS

FIG. 1 is a top plan view of a first storage case of the present invention illustrated in a fully open position;

FIG. 2 is a top plan view of a second storage case;

FIG. 3 is a top plan view of a third storage case:

FIG. 4 is a top plan view of a fourth storage case;

FIG. 5 is an enlarged view of an alternative binder ring arrangement for the cases shown as a three ring binder;

FIG. 6 is an enlarged view of an alternative binder ring arrangement for the cases shown as a tab receiving mechanism;

FIG. 7 is a perspective view of the case of FIG. 1 showing a sleeve being removed therefrom and an article being removed from the sleeve; and

FIG. 8 is a perspective view of the case of FIG. 1 showing the case being closed.

### DETAILED DESCRIPTION OF PREFERRED EMBODIMENTS

Disclosed herein are detailed descriptions of best presently known modes of carrying out the invention. These descriptions are not to be taken in a limiting sense, but are made merely for the purpose of illustrating the general principles of the invention. The section titles and overall organization of the present detailed description are for the purpose of convenience only and are not intended to limit the present invention.

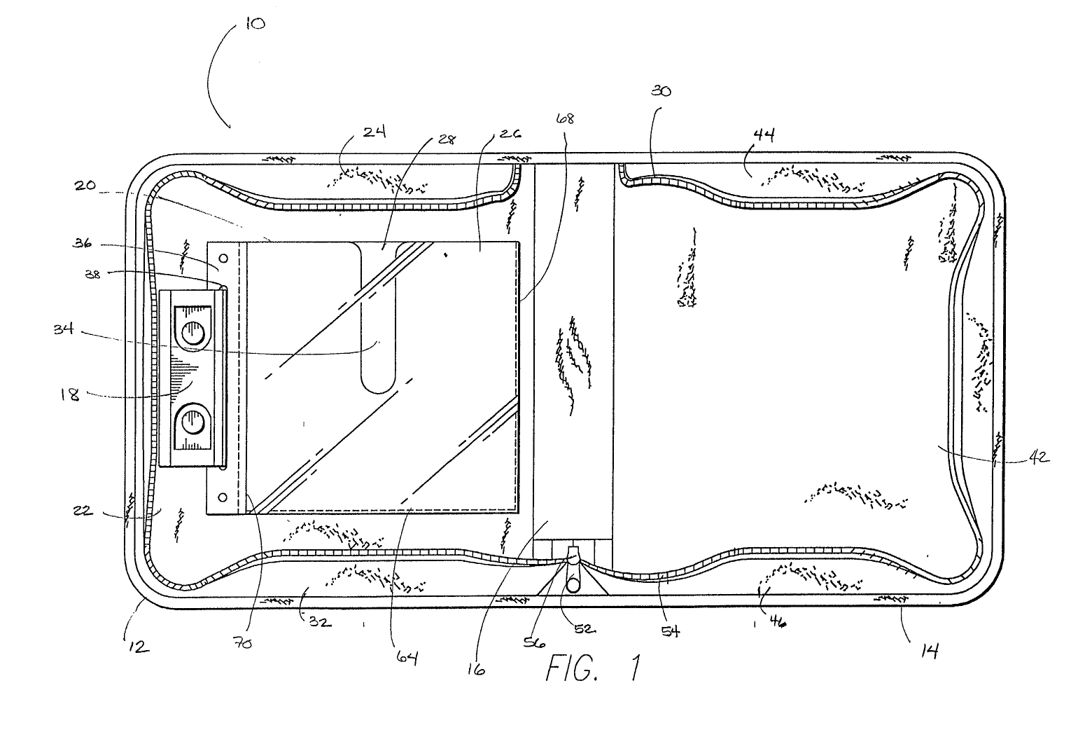

FIG. 1 illustrates a first embodiment of the present invention with the flat article storage case 10 shown in a fully open position. The storage case 10 comprises a first panel 12 and a second panel 14 coupled together by a hinge member 16. The first panel 12 includes a top edge 24, a bottom edge 32, and a side edge 22 opposite the hinge member 16. The second panel 14 includes a top edge 44, a bottom edge 46, and a side edge 42 opposite the hinge member 16. The hinge member 16 allows the storage case 10 to be closed as shown in FIG. 8 by securing the first panel 12 to the second panel 14 via closing member 30 shown as a zipper. The zipper closing member 30 includes a zipper tab 52, zipper teeth 54 and a zipper threader 56 which function together to operate the zipper closing member 30.

The storage case 10 in FIG. 1 also includes at least one holder mechanism 18 which is mounted to at least the first panel 12. The storage case 10 includes at least one sleeve 20 coupled to the holder mechanism 18 for storing flat articles, such as compact discs (CDs) or digital video discs (DVDs). In FIG. 1 a holder mechanism 18 is shown mounted to the side edge 22 of the first panel 12 opposite the hinge member 16. Alternatively, the holder mechanism 18 may be mounted to the second panel 14 at the side edge 42 opposite the hinge member 16. embodiments with a holder mechanism 18 mounted to only the first or second panel 12, 14, may utilize the panel without a holder mechanism 18 to include a pocket such as in the compact disc storage case cdcarrycase™ available from Roundhouse, Inc.

By mounting a holder mechanism 18 to the side edge 22, 42 of the first or second panels 12, 14 opposite from the hinge member 16, flat articles, such as discs 40, may be conveniently stored in the sleeves 20. The disc storage case 10 presents the discs 40 in a flatter design such that more discs 40 may be stored in a case. Additionally, the holder mechanism 18 does not interfere with the hinge member 16 located between the first and second panels 12, 14 so the disc storage case 10 is generally easier to operate. The flatter design of the disc storage case 10 of the present invention also reduces the likelihood of spilling the discs 40 and is easier to operate in small spaces, such as in a car, since the case does not need to be fully opened to locate discs 40.

FIG. 1 also shows the sleeve 20 mounted to the holder mechanism 18 through at least one sleeve hole 38 along sleeve edge 36. The sleeve edge 36 is attached to the sleeve 20 by sealing the edge 36 to the sleeve 20. Alternatively, the sleeve edge 36 may be attached to the sleeve 20 by gluing, stitching, or any other suitable attaching method to secure the sleeve 20 to the edge 36. The sleeve edge 36 may consist of a thicker material than the sleeve 20 such that the edge 36 is less flexible than the sleeve 20. The sleeve 20 also comprises a front cover 26 and a back cover 28 such that the front cover 26 is coupled to the back cover along edges 64, 68 and 70. Edges 64, 68 and 70 form a sealed container adapted to receive and store discs 40. The front cover 26 may include a partial sleeve opening 34 for easy removal of discs 40 from their respective sleeves 20. Additionally, the front cover 26 may be transparent so that users may easily view the disc 40 contained in the sleeve 20.

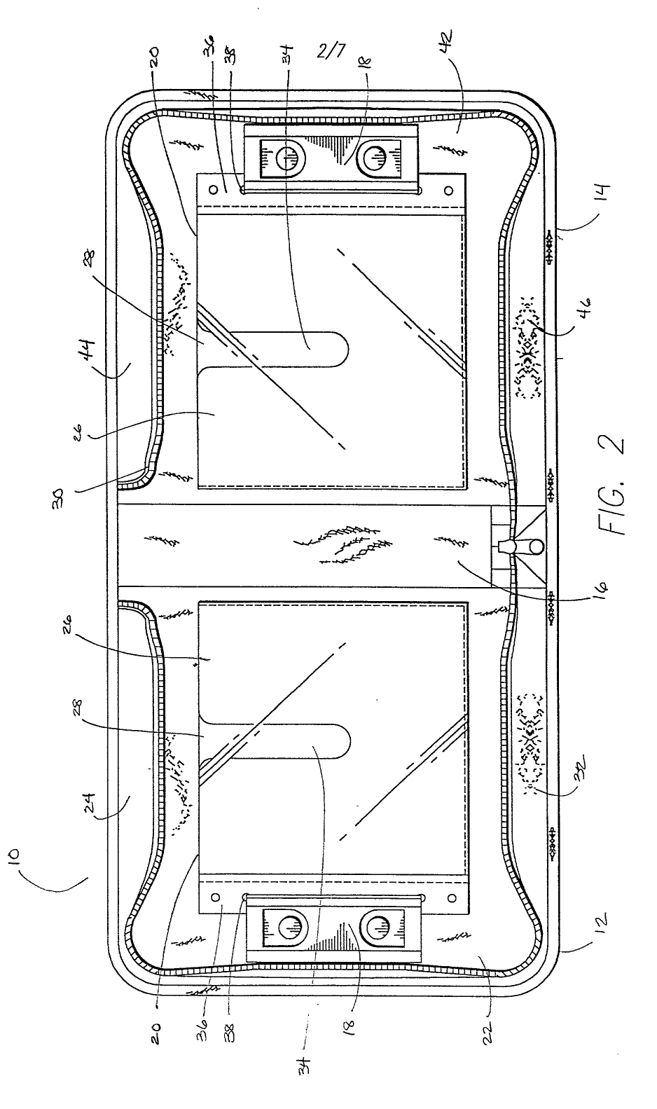

FIG. 2 shows the disc storage case 10 utilizing a holder mechanism 18 mounted to both the first and second panels 12, 14 at the side edges 22, 42, respectively. Sleeves 20 may then be attached to the holder mechanism 18 on both the first and second panels 12, 14. This embodiment incorporates the advantages of the disc storage case 10 shown in FIG. 1 and also allows discs 40 to be stored in two sets of sleeves 20 instead of one. Thus, the disc storage case 10 of FIG. 2 maximizes the amount of discs 40 that may be stored in each case while further enabling the user to easily organize and locate particular discs 40.

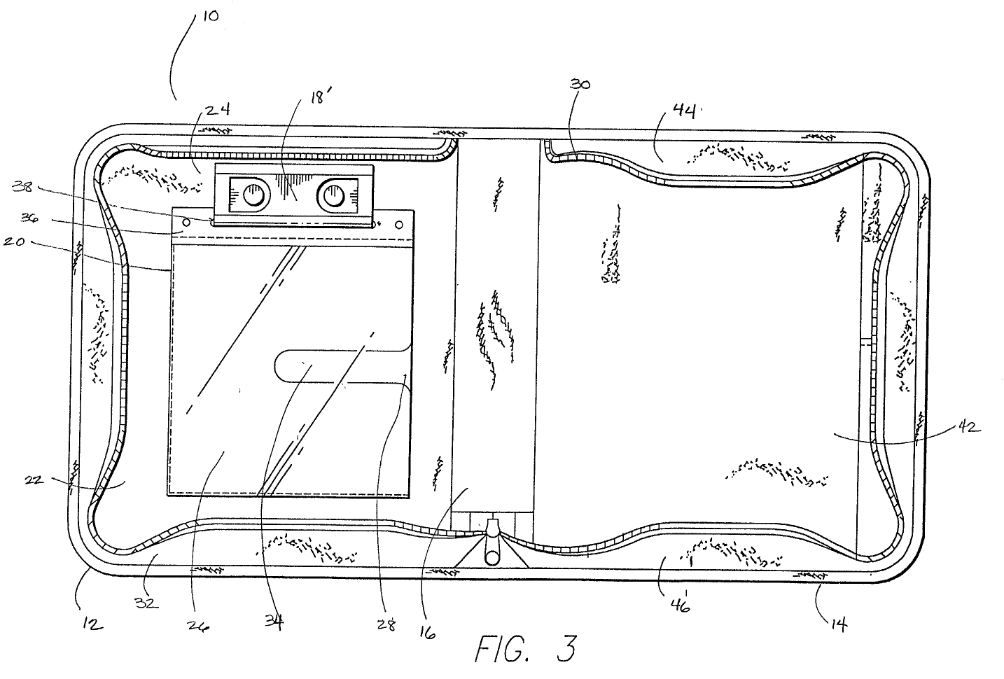

An alternative embodiment of the storage case 10 shown in a fully open position is shown in FIG. 3. In this embodiment, the holder mechanism 18′ is shown coupled to the first panel 12 at the top edge 24 of the first panel 12. Alternatively, the holder mechanism 18′ may be mounted to the second panel 14 at the top edge 44 of the second panel 14. This embodiment provides similar advantages as the disc storage case 10 in FIG. 1, however, users may prefer utilizing sleeves 20 along the top edge 24 as opposed to sleeves 20 coupled to the side edge 22. Thus, holder mechanism 18 may be mounted to the side edge 22, 42 and holder mechanism 18′ may be mounted to the top edge 24, 44 of the first and second panels 12, 14, respectively.

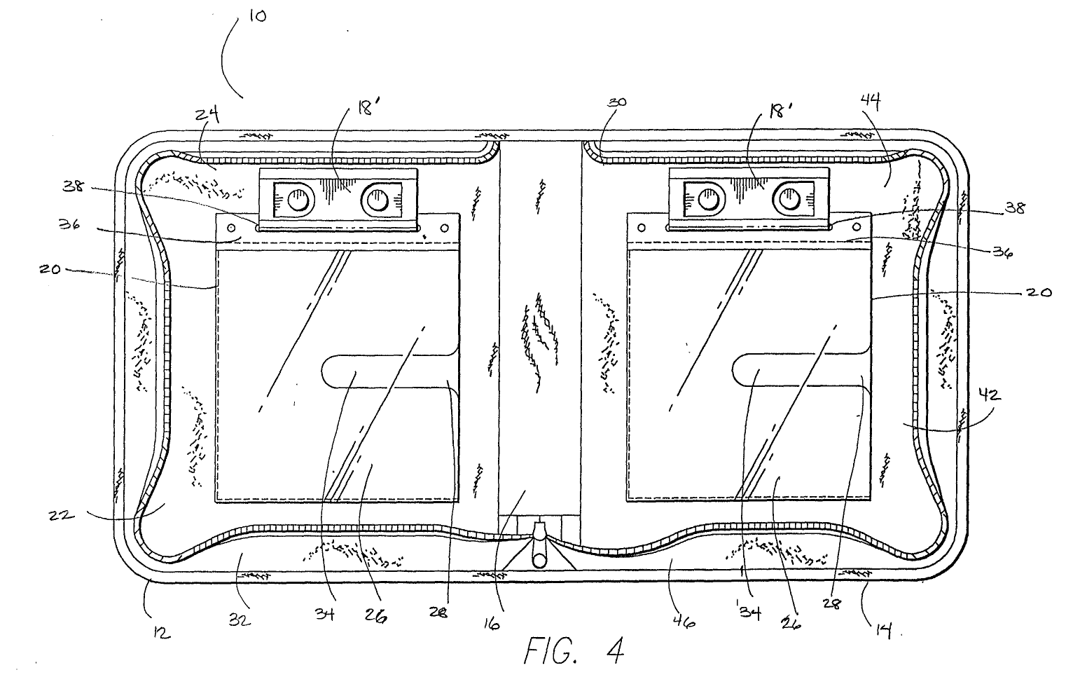

FIG. 4 presents the disc storage case 10 shown in FIG. 3 with the holder mechanism 18′ mounted to both the first and second panels 12, 14 along the top edges 24, 44, respectively. Sleeves 20 may be attached to the holder mechanism 18 on both the first and second panels 12, 14. This embodiment incorporates the advantages of the flatter disc storage case 10 shown in FIG. 3. The disc storage case of FIG. 4 also provides similar advantages as the disc storage case 10 in FIG. 2 including ease in organization of discs 40 and maximum storage capability by providing sleeves 20 on both panels 12, 14.

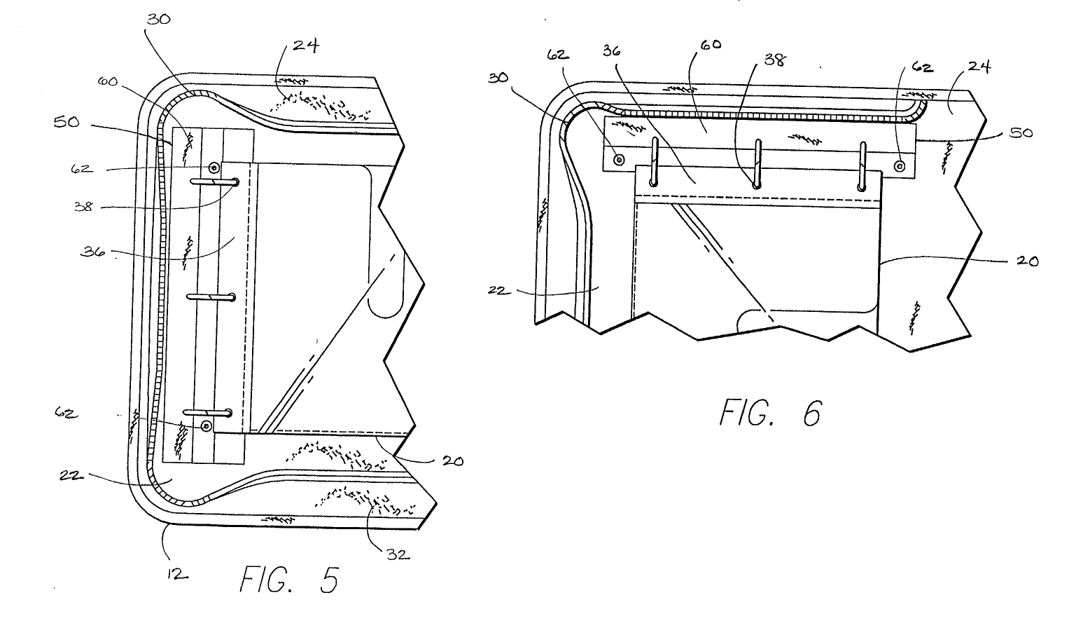

FIGS. 5 and 6 show the holder mechanism 18 as a three ring binder 50 alternative of the disc storage cases of the present invention. The three ring binder 50 is mounted to the first panel 12 through a mounting piece 60. The three ring binder 50 includes rivets 62 on the mounting piece 60 to secure the three ring binder 50 to the first panel 12. The sleeve 20 attaches to the three ring binder 50 through at least one sleeve hole 38 located along the sleeve edge 36. The three ring binder 50 may be pulled open to allow the sleeve holes 38 of the sleeve 20 to be inserted into the three ring binder 50. After the sleeves 20 are inserted into the binder 50, the binder 50 may be pushed closed to secure the sleeves 20 around the binder 50. FIG. 5 shows the three ring binder 50 mounted via the mounting piece 60 along the side edge 22 of the first panel 12. FIG. 6 shows the three ring binder 50 mounted via the mounting piece 60 along the top edge 24 of the first panel 12. Although the binder 50 depicted in FIGS. 5 and 6 is shown with three rings, more rings or less rings may be used. For example, the binder 50 may be implemented with two, four, etc. rings.

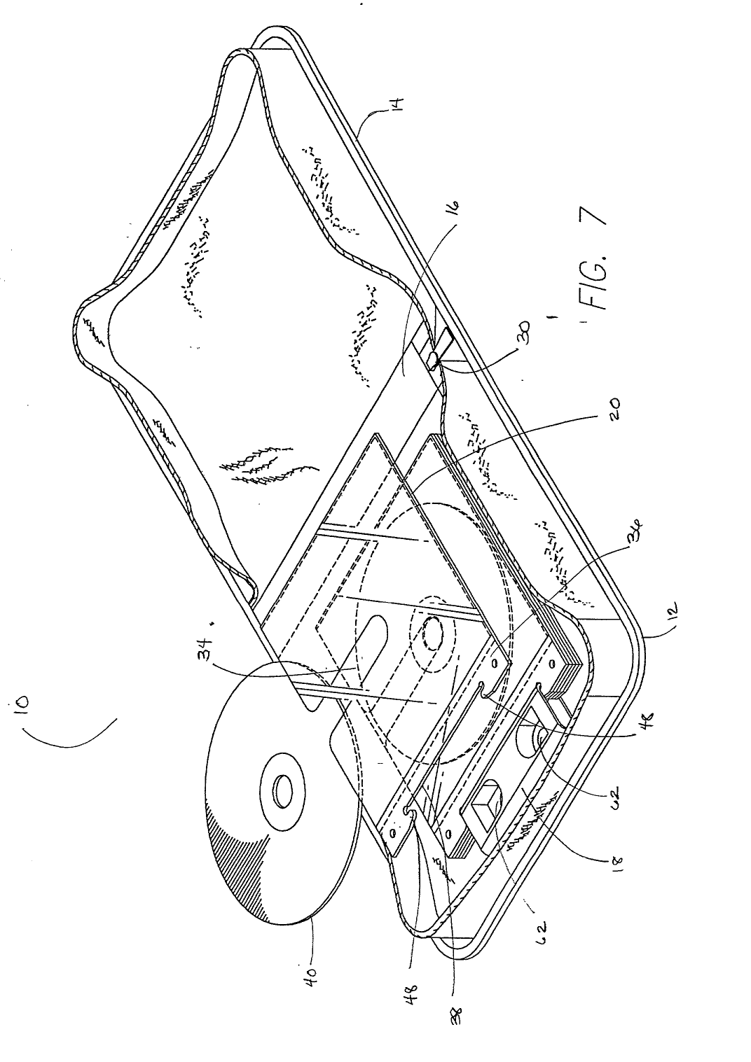

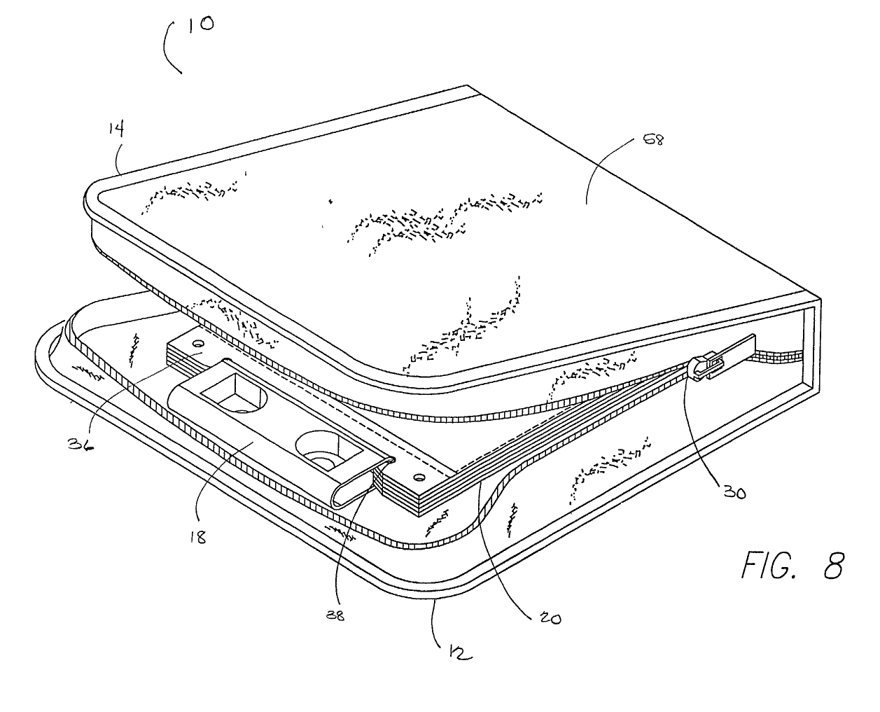

FIG. 7 shows a disc 40 as it is being inserted into a sleeve 20 and a plurality of identical sleeves 20 containing discs 40 with the sleeves 20 stacked one top of each other. The sleeve 20 includes sleeve hole 38 along sleeve edge 36. Unlike FIGS. 5 and 6, the holder mechanism 18 is not a three ring binder 50. Instead, the holder mechanism 18 is adapted to receive tabs 48 on the sleeve 20 adjacent the sleeve hole 38. The tab receiving holder mechanism 18 also includes rivets 62 to mount the holder mechanism 18 to the first panel 12. The sleeves 20 are attached to the tab receiving holder mechanism 18 by manipulating the tabs 48 on the sleeve 20 to cooperate with the holder mechanism 18. For example, the part of the sleeve edge 36 adjacent to the tab 48 may be temporarily twisted or bent to fasten the tab 48 around the holder mechanism 18 such that the tab 48 removably secures the sleeve 20 to the holder mechanism 18. Thus, in a similar manner, the part of the sleeve edge 36 adjacent to the tab 48 may be twisted or bent to remove the sleeve 20 from the holder mechanism 18.

FIG. 8 illustrates the disc storage case 10 being closed via zipper closing member 30. The zipper closing member 30 joins the first panel 12 to the second panel 14 by using zipper tab 52 attached to zipper threader 56 to join the zipper teeth 54 and secure the disc storage case 10 in a closed position. The closing member 30 may also utilize any other clamp or fastener mechanism such as Velcro, snaps, buttons, ties or laces which secures the first panel 12 to the second panel 14 to maintain the case 10 in a closed position.

The case 10 may comprise a hard or soft exterior 58. When the exterior 58 of the case 10 is hard, the case 10 is generally rigid. For example, the hard case can have a high gloss surface that reflects light and minimizes heat absorption thereby providing extra protection for the case contents. When the exterior 58 of the case 10 is soft, the exterior 58 may be formed from a flexible or moveable material. Alternatively, when the exterior 58 of the case 10 is soft, the exterior 58 may include padding or cushioning but the case 10 may or may not be flexible or moveable.

Although the present invention has thus been described in detail with regard to the preferred embodiments and drawings thereof, it should be apparent to those skilled in the art that various adaptations and modifications of the present invention such as changes in the size, shape and materials of the storage case, may be accomplished without departing from the spirit and the scope of the invention. For example, other designs, configurations and constructions of the sleeves can be used. Also, pursuant to this invention, other types of binder or ring systems can be used which removably hold (preferably individually and separately removable) the sleeves (or less preferably hold the sleeves fixed) in the case. Examples thereof include pins and clamps. Further, the sleeve “holders” can be mounted generally anywhere on the panels (but preferably, not directly on the hinge) as would be apparent to those skilled in the art from this disclosure. Accordingly, it is to be understood that the detailed description and the accompanying drawings as set forth hereinabove are not intended to limit the breadth of the present invention.

What is claimed is:

1. A flat article storage case, comprising:
a first panel;
a second panel;
a hinge member located between said first panel and said second panel coupling said first and second panels;
a first sleeve having an opening adapted to receive therein a flat article;
a second sleeve having an opening adapted to receive therein a flat article; and
a holder mechanism mounted to the first panel and adapted to releasably hold said first and second sleeves relative to the first panel wherein said first and second sleeves are individually removable from said holder mechanism.

2. The storage case according to claim 1 wherein said first panel further comprises:
a top edge;
a bottom edge;
a side edge adjacent to said hinge member; and
a side edge opposite said hinge member such that said holder mechanism is mounted to the first panel at said side edge opposite said hinge member of said first panel.

3. The storage case according to claim 1 wherein said first panel further comprises:
a top edge;
a bottom edge;
a side edge adjacent to said hinge member; and
a side edge opposite said hinge member such that said holder mechanism is mounted to said first panel at said top edge of said first panel.

4. The storage case according to claim 2 wherein said second panel further comprises:
a top edge;
a bottom edge;
a side edge adjacent to said hinge member; and
a side edge opposite said hinge member such that said holder mechanism is mounted to the second panel at said side edge opposite said hinge member of said second pane.

5. The storage case according to claim 3 wherein said second panel further comprises:
a top edge;
a bottom edge;
a side edge adjacent to said hinge member; and
a side edge opposite said hinge member such that said holder mechanism is mounted to the second panel at said top edge of said second panel.

6. The storage case according to claim 1 wherein said first and second sleeves further comprise a first front cover with at least three edges and a back cover with at least three edges wherein said first front cover is coupled to said back cover along said at least three edges.

7. The storage case according to claim 1 wherein said first and second sleeves further comprise a second front cover with at least three edges wherein said second front cover is coupled to said back cover along said at least three edges.

8. The storage case according to claim 7 wherein said first and second front cover of said first and second sleeves comprise transparent material.

9. The storage case according to claim 1 wherein said first and second sleeves further comprise a partial opening along the center of said first and second front cover of said first and second sleeves.

10. The storage case according to claim 1 wherein said first and second sleeves are adapted to hold computer-readable storage discs.

11. The storage case according to claim 1 wherein said first and second sleeves are adapted to hold digital video discs.

12. The storage case according to claim 1 wherein said storage case further comprises a hard external cover.

13. The storage case according to claim 1 wherein said storage case further comprises a soft external cover.

14. The storage case according to claim 1 wherein said first sleeve contains at least one hole along an edge for attaching said first sleeve to said holder mechanism.

15. The storage case according to claim 1 wherein said second sleeve contains at least one hole along an edge for attaching said second sleeve to said holder mechanism such that said holes of said first and second sleeves are aligned.

16. The storage case according to claim 1 further comprising a closing member adapted to secure said storage case in a closed position by joining said first and second panels along said top edge, said bottom edge, and said side edge opposite said hinge member.

17. The storage case according to claim 15 wherein said closing member is a zipper.

18. The storage case according to claim 1 wherein said holder mechanism further comprises a multiple ring mechanism.

19. The storage case according to claim 15 wherein said first and second sleeves further comprise at least one tab along the edge of said first and second sleeves adjacent said sleeve holes.

20. The storage case according to claim 18 wherein said holder mechanism further comprises a tab receiving member for attaching said first and second sleeves to said holder mechanism to cooperate with said at least one tab along the edge of said first and second sleeves.

21. A flat article storage case, comprising:
a first panel;
a second panel;
a hinge mechanism hingedly coupling said first and second panels; and
a holder assembly defining a rotation axis, the holder mechanism being directly mounted on the first panel and spaced from the hinge mechanism;
wherein the holder assembly is adapted to releasably hold an edge of a first sleeve such that the first sleeve is rotatable about the axis and to releasably hold an edge of a second sleeve such that the second sleeve is rotatable about the axis independently of the first sleeve, the first and second sleeves being adapted to releasably hold therein respective flat articles.

22. The storage case according to claim 21 wherein said storage case further comprises a closing member adapted to secure said storage case in a closed position.

23. The storage case according to claim 21 wherein said hinge mechanism further defines a rotation axis such that said first panel is rotatable about said hinge mechanism axis independent of said second panel.

24. The storage case according to claim 21 wherein said first panel further comprises:
a top edge;
a bottom edge;
a side edge adjacent to said hinge mechanism; and
a side edge opposite said hinge mechanism such that said holder assembly is mounted to said first panel at said side edge opposite said hinge mechanism of said first panel.

25. The storage case according to claim 21 wherein said first panel further comprises:
a top edge;
a bottom edge;
a side edge adjacent to said hinge mechanism; and
a side edge opposite said hinge mechanism such that said holder assembly is mounted to said first panel at said top edge of said first panel.

26. The storage case according to claim 21 wherein said second panel further comprises:
a top edge;
a bottom edge;
a side edge adjacent to said hinge mechanism; and
a side edge opposite said hinge mechanism such that said holder assembly is mounted to the second panel at said side edge opposite said hinge mechanism of said second panel.

27. The storage case according to claim 21 wherein said second panel further comprises:
a top edge;
a bottom edge;
a side edge adjacent to said hinge mechanism; and
a side edge opposite said hinge mechanism such that said holder assembly is mounted to the second panel at said top edge of said second panel.

28. The storage case according to claim 21 wherein said first and second sleeves further comprise:
a first front cover with at least three edges;
a back cover with at least three edges wherein said first front cover is coupled to said back cover along said at least three edges; and
a second front cover with at least three edges wherein said second front cover is coupled to said back cover along said at least three edges.

29. The storage case according to claim 21 wherein said first and second sleeves further comprise:
a partial opening along the center of said first and second front cover.

30. The storage case according to claim 21 wherein said first and second front cover of said at least one sleeve comprise transparent material.

31. The storage case according to claim 21 wherein said storage case further comprises a hard external cover.

32. The storage case according to claim 21 wherein said storage case further comprises a soft external cover.

33. The storage case according to claim 21 wherein said first sleeve contains at least one hole along an edge for attaching said first sleeve to said holder assembly.

34. The storage case according to claim 21 wherein said second sleeve contains at least one hole along an edge for attaching said second sleeve to said holder assembly such that said holes of said first and second sleeves are aligned.

35. The storage case according to claim 21 wherein said closing member is a zipper.

36. The storage case according to claim 21 wherein said holder assembly further comprises a three ring mechanism.

37. The storage case according to claim 31 wherein said first and second sleeves further comprise at least one tab along the edge of said first and second sleeves for attaching said first and second sleeves to said holder assembly.

38. The storage case according to claim 37 wherein said holder assembly further comprises a tab receiving member for attaching said first and second sleeves to said holder assembly to cooperate with said at least one tab along the edge of said first and second sleeves.
